(19) United States
(12) Patent Application Publication
(10) Pub. No.: US 2026/0124559 A1
(43) Pub. Date: May 7, 2026

(54) COMPOSITE FILTER CARTRIDGE

(71) Applicant: KEMFLO INTERNATIONAL CO., LTD., Pingtung City (TW)

(72) Inventors: Sheng-Nan LIN, Pingtung City (TW); Cheng-Shing LO, Pingtung City (TW); Mao-Gu LIU, Pingtung City (TW)

(21) Appl. No.: 19/018,993

(22) Filed: Jan. 13, 2025

(30) Foreign Application Priority Data
Nov. 5, 2024 (TW) 113212018

(51) Int. Cl. B01D 27/14; B01D 27/08; C02F 5/10

(52) U.S. Cl. CPC B01D 27/148; B01D 27/08; C02F 5/10; B01D 2201/298; B01D 2239/1216; B01D 2257/2025; B01D 2257/60

(57) ABSTRACT

A composite filter cartridge is adapted to filter raw water to produce purified water, and includes an inner carbon tube, an outer carbon tube, a first end cap, a second end cap, and a plurality of resin granules. The inner carbon tube defines a water outlet channel adapted to output the purified water. The outer carbon tube is concentric with the inner carbon tube, and is spaced apart from the inner carbon tube. The first and second end caps respectively limit two ends of the inner and outer carbon tubes. The first end cap closes an end of the water outlet channel. The second end cap has a water outlet communicating with the water outlet channel. The second end cap cooperates with the inner carbon tube, the outer carbon tube, and the first end cap to define a resin granule accommodation space where the resin granules are accommodated.

### CROSS-REFERENCE TO RELATED APPLICATION

This application claims priority to Taiwanese Utility Model Patent Application No. 113212018, filed on Nov. 5, 2024, the entire disclosure of which is incorporated by reference herein.

### FIELD

The disclosure relates to a filter cartridge, and more particularly to a composite filter cartridge.

### BACKGROUND

A conventional water purifier system usually includes a plurality of filter cartridges each of which contains a single filter material and which are connected in series to purify water, and a plurality of mounting seats that are for the filter cartridges to be respectively mounted and fixed thereto. Because of such configurations, the conventional water purifier system is bulky and costly. Furthermore, the filter cartridges have to be replaced and maintained individually, which is complicated, thereby resulting in poor user experience.

### SUMMARY

Therefore, an object of the disclosure is to provide a composite filter cartridge that can alleviate at least one of the drawbacks of the prior art.

According to the disclosure, the composite filter cartridge is adapted to filter raw water, and includes an inner carbon tube, an outer carbon tube, a first end cap, a second end cap, and a plurality of resin granules. The inner carbon tube is adapted to filter heavy metals out of the raw water to produce purified water, and defines a water outlet channel adapted to output the purified water. The outer carbon tube is adapted to filter chlorine out of the raw water, is concentric with the inner carbon tube, and is spaced apart from the inner carbon tube. The first end cap limits an end of the inner carbon tube and an end of the outer carbon tube, and closes an end of the water outlet channel. The second end cap is spaced apart from the first end cap, and limits another end of the inner carbon tube and another end of the outer carbon tube. The second end cap has a water outlet that communicates with the water outlet channel. The second end cap cooperates with the inner carbon tube, the outer carbon tube, and the first end cap to define a resin granule accommodation space. The resin granules are accommodated in the resin granule accommodation space, and are adapted to soften the raw water.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a sectional view illustrating an embodiment of a composite filter cartridge according to the disclosure.

FIG. 2 is a sectional view taken in another direction, illustrating the composite filter cartridge.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

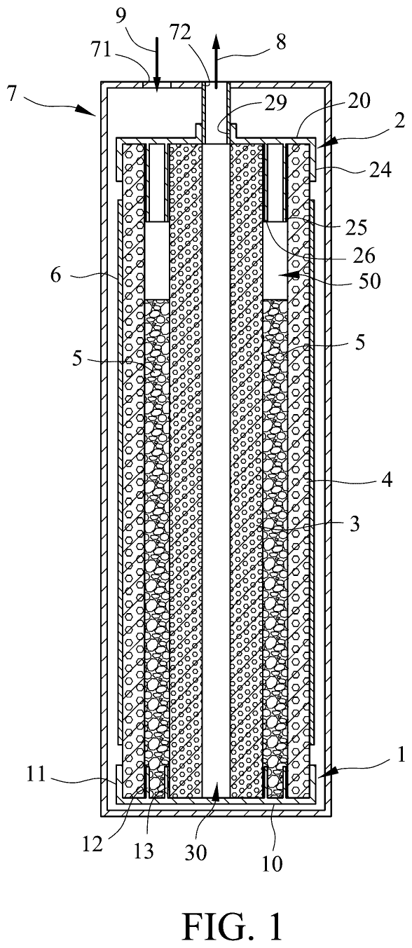

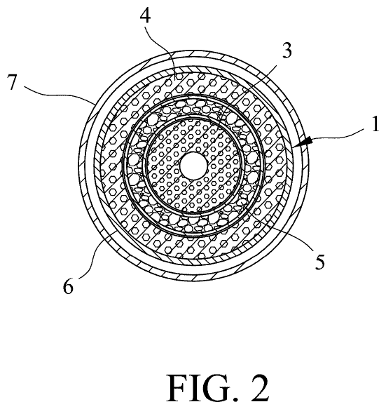

Referring to FIGS. 1 to 2, according to the disclosure, an embodiment of a composite filter cartridge is adapted to filter raw water 9 (e.g., tap water, etc.) to produce purified water 8, and includes a housing 7, a filter cloth 6, an outer carbon tube 4, a plurality of resin granules 5, an inner carbon tube 3, a first end cap 1, and a second end cap 2.

In this embodiment, the housing 7 accommodates the filter cloth 6, the outer carbon tube 4, the resin granules 5, the inner carbon tube 3, the first end cap 1, and the second end cap 2.

In this embodiment, the filter cloth 6 covers an outer surface of the outer carbon tube 4, is spaced apart from the first end cap 1 and the second end cap 2, and is adapted to filter large particles of impurities (e.g., sediment, etc.) out of the raw water 9 in a first filtration procedure. In this embodiment, the filter cloth 6 has a plurality of pores each of which has a pore size ranging from 15 micrometers to 50 micrometers (μm).

The outer carbon tube 4 surrounds the inner carbon tube 3, is spaced apart from the inner carbon tube 3, and is adapted to filter chlorine out of the raw water 9 in a second filtration procedure. In this embodiment, the outer carbon tube 4 has a plurality of pores each of which has a pore size ranging from 5 μm to 30 μm.

The resin granules 5 are adapted to soften the raw water 9 in a third filtration procedure. In this embodiment, the resin granules 5 use weak acid cations to soften the raw water 9.

The inner carbon tube 3 is adapted to filter heavy metals out of the raw water 9 to produce the purified water 8 in a fourth filtration procedure. The inner carbon tube 3 is concentric with the outer carbon tube 4 and is spaced apart from the outer carbon tube 4. The inner carbon tube 3 defines a water outlet channel 30 that is adapted to output the purified water 8. The heavy metals filtered out by the inner carbon tube 3 may include at least one of lead and/or mercury. In this embodiment, the inner carbon tube 3 has a plurality of pores each of which has a pore size ranging from 0.5 μm to 5 μm.

The first end cap 1 limits an end of the inner carbon tube 3 and an end of the outer carbon tube 4, and closes an end of the water outlet channel 30. In this embodiment, the first end cap 1 includes a base wall 10 that limits the outer carbon tube 4 and the inner carbon tube 3, the first limiting ring 11 that extends from a periphery of the base wall 10 toward the second end cap 2 and that limits the outer surface of the outer carbon tube 4, a second limiting ring 12 that extends from the base wall 10 toward the second end cap 2 and that limits an inner surface of the outer carbon tube 4, and a third limiting ring 13 that extends from the base wall 10 toward the second end cap 2 and that limits an outer surface of the inner carbon tube 3. For the first end cap 1, the second limiting ring 12 is located between the first limiting ring 11 and the third limiting ring 13.

The second end cap 2 is spaced apart from the first end cap 1, and limits another end of the inner carbon tube 3 and another end of the outer carbon tube 4. The second end cap 2 has a water outlet 29 that communicates with the water outlet channel 30. The second end cap 2 cooperates with the inner carbon tube 3, the outer carbon tube 4, and the first end cap 1 to define a resin granule accommodation space 50 where the resin granules 5 are accommodated. In this embodiment, the second end cap 2 includes an annular plate 20 that limits the outer carbon tube 4 and the inner carbon tube 3 and that defines the water outlet 29, a first limiting ring 24 that extends from an outer periphery of the annular plate 20 toward the first end cap 1 and that limits the outer surface of the outer carbon tube 4, a second limiting ring 25 that extends from the annular plate 20 toward the first end cap 1 and that limits the inner surface of the outer carbon tube 4, and a third limiting ring 26 that extends from the annular plate 20 toward the first end cap 1 and that limits the outer surface of the inner carbon tube 3. For the second end cap 2, the second limiting ring 25 is located between the first limiting ring 24 and the third limiting ring 26.

It should be noted that, in this embodiment, the resin granules 5 do not completely fill the resin granule accommodation space 50. For example, as shown in FIG. 1, an upper section of the resin granule accommodation space 50 is reserved so that the resin granules 5 may flow inside the resin granule accommodation space 50.

In this embodiment, the housing 7 is formed with a water inlet hole 71 that is adapted for input of the raw water 9 so that the raw water 9 percolates through the filter cloth 6, and a water outlet hole 72 that communicates with the water outlet 29 of the second end cap 2.

The process of filtering the raw water 9 using the composite filter cartridge of the disclosure is roughly as follows. First, in the first filtration procedure, the raw water 9 passes through the filter cloth 6 to filter out the large particles of impurities (e.g., sediment, etc.). Next, in the second filtration procedure, the raw water 9 passes through the outer carbon tube 4 to filter out chlorine. Then, in the third filtration procedure, the raw water 9 passes through the resin granules 5 to be soften. Finally, in the fourth filtration procedure, the raw water 9 passes through the inner carbon tube 3 to filter out the heavy metals to produce the purified water 8, and the purified water 8 flows out through the water outlet channel 30.

In summary, the composite filter cartridge of the disclosure has at least the following advantages and effects: (1) The composite filter cartridge may filter the heavy metals out of the raw water 9 by using the inner carbon tube 3, may soften the raw water 9 by using the resin granules 5, and may filter chlorine out of the raw water 9 by using the outer carbon tube 4. Therefore, a single composite filter cartridge of the disclosure may achieve multiple filtration effects. (2) In the first filtration procedure, the composite filter cartridge may filter large particles of impurities (e.g., sediment, etc.) out of the raw water 9 by using the filter cloth 6. (3) The first limiting ring 11 of the first end cap 1 may limit the outer surface of the outer carbon tube 4. (4) The second limiting ring 12 of the first end cap 1 may limit the inner surface of the outer carbon tube 4. (5) The third limiting ring 13 of the first end cap 1 may limit the outer surface of the inner carbon tube 3. (6) The first limiting ring 24 of the second end cap 2 may limit the outer surface of the outer carbon tube 4. (7) The second limiting ring 25 of the second end cap 2 may limit the inner surface of the outer carbon tube 4. (8) The third limiting ring 26 of the second end cap 2 may limit the outer surface of the inner carbon tube 3. That is to say, the first end cap 1 cooperates with the second end cap 2 to limit the inner carbon tube 3 and the outer carbon tube 4. (9) The composite filter cartridge is relatively small in volume and incurs low cost. Furthermore, the composite filter cartridge is easy to be replaced and maintained, and so user experience is improved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A composite filter cartridge adapted to filter raw water, comprising:
an inner carbon tube that is adapted to filter heavy metals out of the raw water to produce purified water, and that defines a water outlet channel adapted to output the purified water;
an outer carbon tube that is adapted to filter chlorine out of the raw water, that is concentric with said inner carbon tube, and that is spaced apart from said inner carbon tube;
a first end cap that limits an end of said inner carbon tube and an end of said outer carbon tube, and that closes an end of said water outlet channel;
a second end cap that is spaced apart from said first end cap, and that limits another end of said inner carbon tube and another end of said outer carbon tube, said second end cap having a water outlet that communicates with said water outlet channel, said second end cap cooperating with said inner carbon tube, said outer carbon tube, and said first end cap to define a resin granule accommodation space; and
a plurality of resin granules that are accommodated in said resin granule accommodation space, and that are adapted to soften the raw water.

2. The composite filter cartridge as claimed in claim 1, wherein the heavy metals filtered out by said inner carbon tube include at least one of lead or mercury.

3. The composite filter cartridge as claimed in claim 1, wherein said inner carbon tube has a plurality of pores each of which has a pore size ranging from 0.5 micrometers to 5 micrometers.

4. The composite filter cartridge as claimed in claim 1, wherein said outer carbon tube has a plurality of pores each of which has a pore size ranging from 5 micrometers to 30 micrometers.

5. The composite filter cartridge as claimed in claim 1, wherein said first end cap includes a base wall that limits said outer carbon tube and said inner carbon tube, a first limiting ring that extends from a periphery of said base wall toward said second end cap and that limits an outer surface of said outer carbon tube, a second limiting ring that extends from said base wall toward said second end cap and that limits an inner surface of said outer carbon tube, and a third limiting ring that extends from said base wall toward said second end cap and that limits an outer surface of said inner carbon tube.

6. The composite filter cartridge as claimed in claim 1, wherein said second end cap includes an annular plate that limits said outer carbon tube and said inner carbon tube and that defines said water outlet, a first limiting ring that extends from an outer periphery of said annular plate toward said first end cap and that limits an outer surface of said outer carbon tube, a second limiting ring that extends from said annular plate toward said first end cap and that limits an inner surface of said outer carbon tube, and a third limiting ring that extends from said annular plate toward said first end cap and that limits an outer surface of said inner carbon tube.

7. The composite filter cartridge as claimed in claim 1, wherein said plurality of resin granules use weak acid cations to soften the raw water.

8. The composite filter cartridge as claimed in claim 1, further comprising a filter cloth that covers an outer surface of said outer carbon tube, said filter cloth being spaced apart from said first end cap and said second end cap, and being adapted to filter large particles of impurities out of the raw water.

9. The composite filter cartridge as claimed in claim 8, wherein said filter cloth has a plurality of pores each of which has a pore size ranging from 15 micrometers to 50 micrometers.

10. The composite filter cartridge as claimed in claim 8, further comprising a housing that accommodates said inner carbon tube, said outer carbon tube, said first end cap, said second end cap, said plurality of resin granules, and said filter cloth, said housing being formed with a water inlet hole that is adapted for input of the raw water so that the raw water percolates through said filter cloth, and a water outlet hole that communicates with said water outlet of said second end cap.
